(19) United States
(12) Patent Application Publication
(10) Pub. No.: US 2025/0371845 A1
(43) Pub. Date: Dec. 4, 2025

(54) ELECTRONIC DEVICE AND METHOD OF IDETIFYING CIRCUIT BOARD THEREOF

(71) Applicant: ADVANTEST CORPORATION, Tokyo (JP)

(72) Inventors: Yiyun Zhang, Tokyo (JP); Martin Schmitz, Tokyo (JP); Shucheng Hu, Tokyo (JP); Siyuan Geng, Tokyo (JP)

(21) Appl. No.: 19/211,059

(22) Filed: May 16, 2025

(30) Foreign Application Priority Data
Jun. 3, 2024 (CN) 202410708876.5

(51) Int. Cl. G06V 10/764; G06T 11/00

(52) U.S. Cl. CPC G06V 10/764; G06T 11/00

(57) ABSTRACT

An electronic device and a method of identifying a circuit board thereof are disclosed. The electronic device includes a processing circuit, a storing circuit, a display panel, and a camera. The method includes utilizing the camera to capture an image from a first circuit board corresponding to the camera; identifying the first circuit board as a second circuit board based on a plurality of circuit board images stored in the storing circuit, wherein the image of the second circuit board is one of the plurality of circuit board images; and displaying the image of the first circuit board corresponding to the camera, a serial number corresponding to the first circuit board, and a virtual frame enclosing real pins of the first circuit board on the display panel at the same time. The locations of the real pins of the circuit board in time through the electronic device can be obtained.

### CROSS-REFERENCE TO RELATED PATENT APPLICATION

This application claims priority to China Patent Application No. 202410708876.5, filed on Jun. 3, 2025. The entire contents of China Patent Application No. 202410708876.5 are incorporated herein by reference.

### FIELD OF THE INVENTION

The present invention relates to a technique of circuit boarding identification, and more particularly to an electronic device and a method of identifying a circuit board thereof.

### BACKGROUND OF THE INVENTION

Nowadays, before testing a circuit board, users typically check relevant files through a computer or printing the files out directly so as to find correct pins for testing. However, when comparing the circuit board with its corresponding files, it might become time-consuming for users to find out the correct pin locations on the circuit board according to the layout distribution of the circuit board, the density of pins, and the quantity of pins.

### SUMMARY OF THE INVENTION

The present invention provides an electronic device and a method of identifying a circuit board thereof, thereby saving time for find out the correct pin locations of the circuit board.

According to an embodiment, a method of identifying a circuit board is performed by an electronic device including a processing circuit, a storage circuit, a display panel, and a camera. The method includes: utilizing the camera to capture an image from a first circuit board corresponding to the camera; identifying the first circuit board as a second circuit board based on a plurality of circuit board images stored in the storage circuit, wherein the image of the second circuit board is one of the plurality of circuit board images stored in the storage circuit; and displaying the image of the first circuit board corresponding to the camera, a serial number corresponding to the first circuit board, and a virtual frame enclosing real pins of the first circuit board on the display panel at the same time.

In an embodiment, the method further includes loading a pin configuration file to display positions of the real pins and signal categories that the real pins connect to on the display panel.

In an embodiment, the method further includes loading a pin label file to display a specification and a manual of the real pins on the display panel.

In an embodiment, the display panel includes a searching interface for searching a specific real pin and displaying a specification and a manual of the specific real pin.

In an embodiment, the electronic device is a smart phone or an augmented reality (AR) wearable device.

According to an embodiment of the present invention, an electronic device is provided to perform a method of identifying a circuit board. The electronic device includes a processing circuit, a storage circuit, a display panel, and a camera. The method includes: utilizing the camera to capture an image from a first circuit board corresponding to the camera; identifying the first circuit board as a second circuit board based on a plurality of circuit board images stored in the storage circuit, wherein the image of the second circuit board is one of the plurality of circuit board images stored in the storage circuit; and displaying the image of the first circuit board corresponding to the camera, a serial number corresponding to the first circuit board, and a virtual frame enclosing real pins of the first circuit board on the display panel at the same time.

In an embodiment, the method further includes loading a pin configuration file to display positions of the real pins and signal categories that the real pins connect to on the display panel.

In an embodiment, the method further includes loading a pin label file to display a specification and a manual of the real pins on the display panel.

In an embodiment, the display panel includes a searching interface for searching a specific real pin and displaying a specification and a manual of the specific real pin.

In an embodiment, the electronic device is a smart phone or an augmented reality (AR) wearable device.

The present invention utilizes a technique of image recognition to quickly identify the type of the circuit boards and the information of pins therein. Therefore, the electronic device for identifying a circuit board and the method of identifying a circuit board provided by the present invention can save users time on finding out the correct pin locations on the circuit board.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of an electronic device for identifying a circuit board according to an embodiment of the present invention.

FIG. 2 is a flow chart of a method of identifying a circuit board according to an embodiment of the present invention.

FIG. 3 is a schematic diagram of displaying a serial number corresponding to a circuit board and a virtual frame enclosing real pins of the circuit board on a display panel according to an embodiment of the present invention.

FIG. 4 is a flow chart of a method of identifying a circuit board according to another embodiment of the present invention.

FIG. 5 is a schematic diagram of displaying locations of the real pins and signal categories that the real pins connect to on a display panel according to an embodiment of the present invention.

FIG. 6 is a flow chart of a method of identifying a circuit board according to yet another embodiment of the present invention.

FIG. 7 is a schematic diagram of displaying a specification and a manual of the real pins on a display panel according to an embodiment of the present invention.

### DETAILED DESCRIPTION OF PREFERRED EMBODIMENTS

The present invention is particularly described with the following examples, which are merely for illustration. For those skilled in the art, various modifications and refinements can be made without departing from the spirit and scope of this disclosure. Therefore, the scope of protection of this disclosure shall be defined by the appended claims. Throughout the specification and claims, unless clearly specified otherwise, the meaning of “a” and “the” includes “one or at least one” element or component. In addition, as used in the present invention, unless it is clearly apparent from the context that the plural is excluded, the singular also includes the plural elements or components. Additionally, when used in this description and all the following claims, unless clearly specified otherwise, “therein” can mean “in” and “on”. The terms used throughout this specification and claims, unless specifically noted, usually have their ordinary meanings in the field, in the context of this disclosure, and in the specific context. Some terms used to describe the present invention will be discussed below or elsewhere in this specification to provide additional guidance to a practitioner regarding the description of the present invention. Any examples given anywhere throughout the specification, including the use of any terms discussed herein, are merely for description and do not limit the scope and meaning of the present invention or any exemplified terms. Likewise, the present invention is not limited to the various embodiments proposed in this specification.

Furthermore, if a term “coupled” or “connected” is used herein, it includes any direct and indirect electrical connection measures. For example, a text describes that a first apparatus is electrically coupled to a second apparatus, meaning that the first apparatus may be connected to the second apparatus directly or indirectly via through other apparatuses or connection measures. Additionally, if a description involves transmission or provision of electrical signals, those skilled in the art should understand that the transmission of electrical signals may be accompanied by attenuation or other non-ideal changes, but unless specifically stated otherwise, the electrical signals transmitted or provided from sources to receiving ends should be considered as substantially the same signal. For example, in a case that an electrical signal S is transmitted (or provided) from an endpoint A of an electronic circuit to an endpoint B, where it may pass by the source and drain terminals of a transistor switch and/or a possible stray capacitor, causing a voltage drop, but if the objective of such design is not to intentionally use the attenuation or other non-ideal changes during transmission (or provision) to achieve certain technical effects, the electrical signal S at the endpoint A and the electrical signal S at the endpoint B of the electronic circuit should be considered substantially the same signal.

It can be understood that the terms “comprising,” “including,” “having,” “containing,” “involving,” and the like as used herein are open-ended, meaning inclusion but being not limited thereto. Additionally, any embodiment or claim of the present invention does not have to achieve all the objectives, advantages, or features disclosed in the present invention. Furthermore, the abstract and title are only for assisting in patent document searches and are not intended to limit the claims of the present invention.

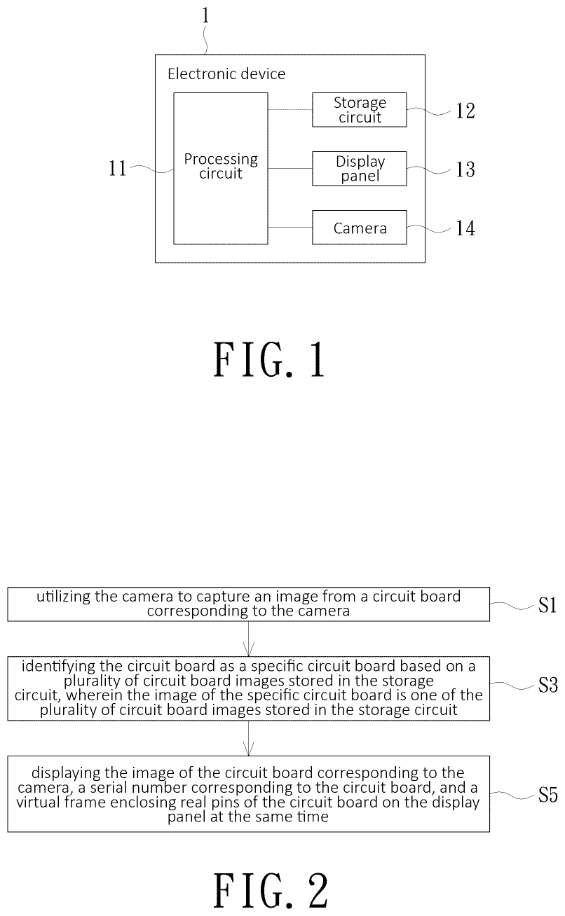

Please refer to FIG. 1 which is a schematic diagram of an electronic device for identifying a circuit board according to an embodiment of the present invention. According to the embodiment, the present invention provides an electronic device 1 including a processing circuit 11, a storage circuit 12, a display panel 13, and a camera 14. The processing circuit 11 is electrically coupled to the storage circuit 12, the display panel 13, and the camera 14. In addition, the electronic device 1 is a smart phone or an augmented reality (AR) wearable device for performing a method of identifying a circuit board.

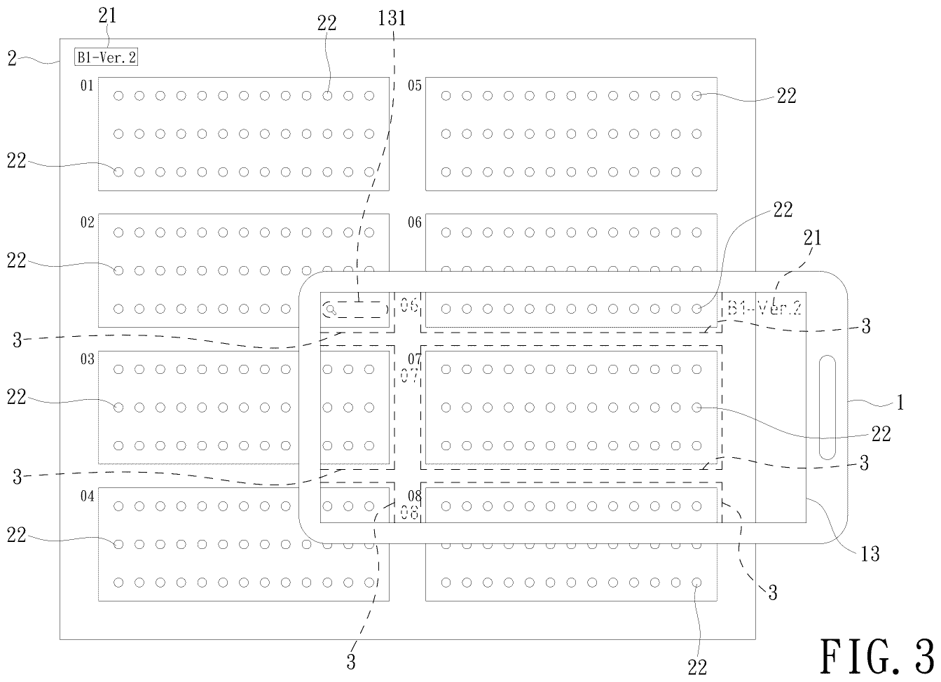

Please refer to FIG. 2 which is a flow chart of a method of identifying a circuit board according to an embodiment of the present invention. The method of identifying a circuit board provided by the present invention is stored in the storage circuit 12 and performs the following steps through the processing circuit 11. Step S1 is utilizing the camera 14 to capture an image from a circuit board 2 corresponding to the camera 14. Step S3 is identifying the circuit board 2 as a specific circuit board based on a plurality of circuit board images stored in the storage circuit 12, wherein the image of the specific circuit board is one of the plurality of circuit board images stored in the storage circuit 12. Step S5 is displaying the image of the circuit board 2 corresponding to the camera 14, a serial number 21 corresponding to the circuit board 2, and a virtual frame 3 (including the frame No.) enclosing real pins 22 of the circuit board 2 on the display panel 13 at the same time. Please refer to FIG. 3 which is a schematic diagram of displaying a serial number corresponding to a circuit board and a virtual frame enclosing real pins of the circuit board on a display panel according to one embodiment of the present invention. In the embodiment, the electronic device 1 is illustrated as a smart phone. A user can view the images of the circuit board 2, the serial number 21 of the circuit board 2 (shown in dash lines), and the virtual frame 3 (shown in dash lines) enclosing the real pins 22 of the circuit board 2 from a display panel 13 of a smart phone at the same time. It is noted that the plurality of circuit board images can be downloaded to the storage circuit 12 of the electronic device 1 through a wired or wireless connection to a work station, a server, a cloud, etc. However, it is not limited thereto. The circuit board images can also be captured by users and then stored in the storage circuit 12.

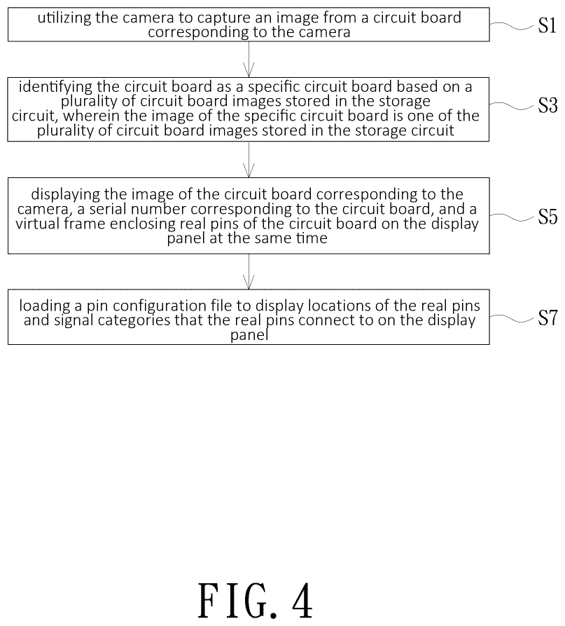

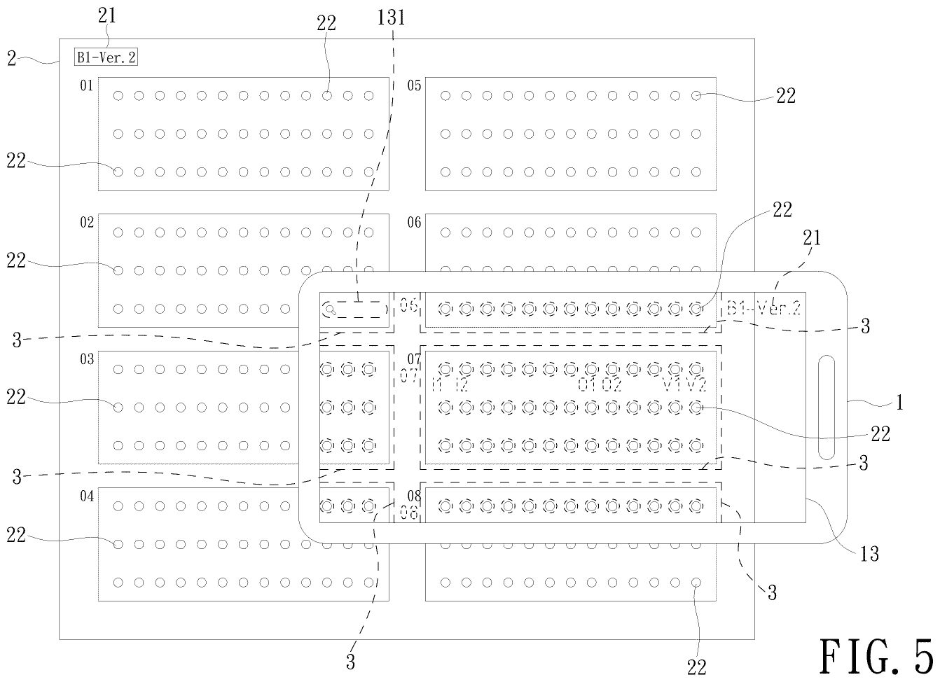

Please refer to FIG. 4 which is a flow chart of a method of identifying a circuit board according to another embodiment of the present invention. In this embodiment, the method of identifying a circuit board not only includes all steps aforementioned but also includes Step S7 which is loading a pin configuration file to display locations of the real pins 22 and signal categories that the real pins connect to on the display panel 13. Please refer to FIG. 5 which is a schematic diagram of displaying locations of the real pins and signal categories that the real pins connect to on a display panel according to an embodiment of the present invention. In this embodiment, the electronic device 1 is illustrated as a smart phone. The display panel 13 includes a searching interface 131. A user can view the images of the circuit board 2 on the display panel 13 of the smart phone. In addition, after the pin configuration file of the circuit board 2 is loading in the searching interface 131, the display panel 13 can display the serial number 21 of the circuit board 2 (shown in dash lines), the virtual frame 3 (shown in dash lines) enclosing the read pins 22, locations of the real pins 22, and signal categories that the real pins 22 connect to (shown in dash lines) (different colors, such as red, green, yellow, etc., can be used to represent different signal categories. For example, input I1 and 12 can be shown in green, Output O1 and 02 can be shown in yellow, and Voltage V1 and V2 can be shown in red) at the same time. In addition, it is noted that the pin configuration files can be downloaded to the storage circuit 12 of the electronic device 1 through a wired or wireless connection to a work station, a server, a cloud, etc.

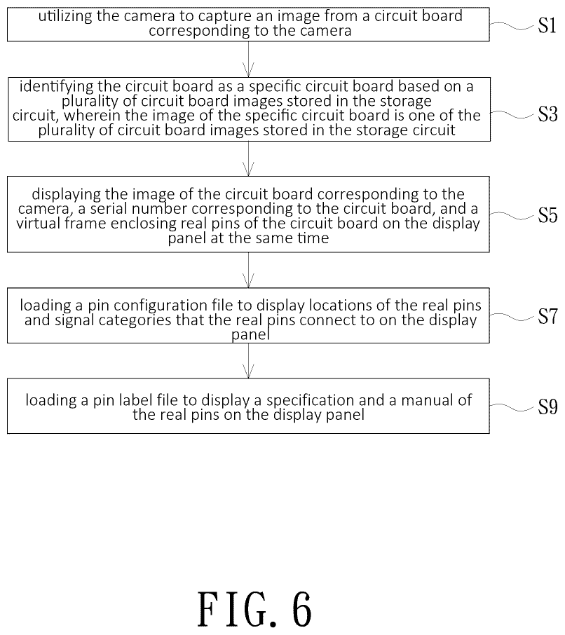

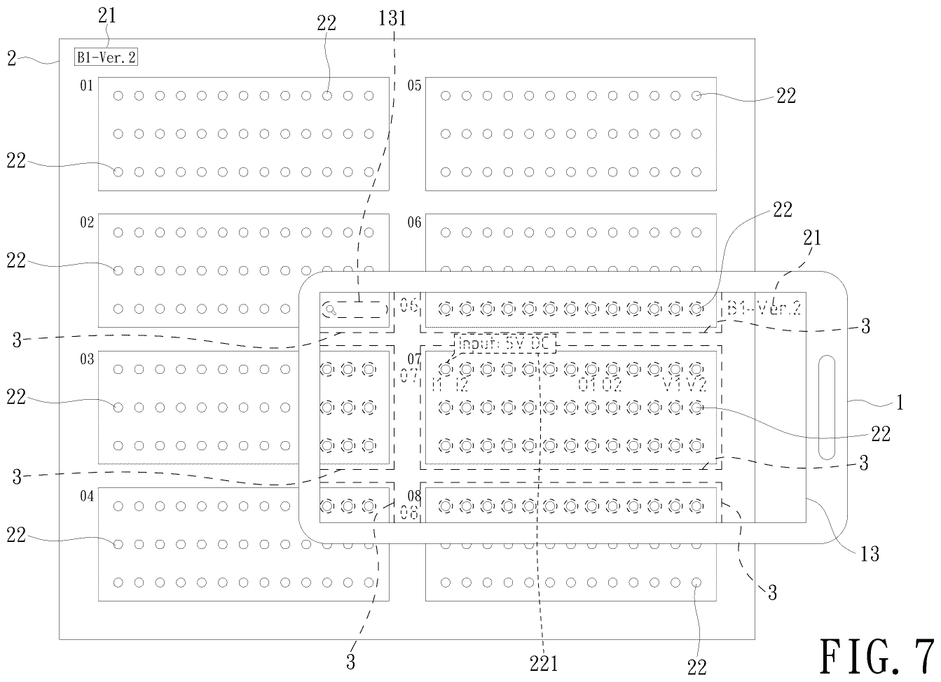

Please refer to FIG. 6 which is a flow chart of a method of identifying a circuit board according to yet another embodiment of the present invention. In this embodiment, the method not only includes all steps aforementioned but also includes Step S9 which is loading a pin label file to display a specification and a manual of the real pins on the display panel. Please refer to FIG. 7 which is a schematic diagram of displaying a specification and a manual of the real pins on a display panel according to an embodiment of the present invention. In the embodiment, the electronic device 1 is illustrated as a smart phone. The display panel 13 includes a searching interface 131. A user can view the images of the circuit board 2 on the display panel 13 of the smart phone. After a pin label file of the circuit board 2 is loaded to the searching interface 131, the display panel 13 can display the images of the circuit board 2 together with the serial number 21 of the circuit board 2 (shown in dash lines), the virtual frame 3 (shown in dash lines) enclosing the read pins 22, locations of the real pins 22, signal categories that the real pins 22 connect to (shown in dash lines), a specification the real pins 22, and a manual of the real pins 22 (shown in dash lines) (such as input/output power or input/output waveform). In addition, it is noted that the pin label files can be downloaded to the storage circuit 12 of the electronic device 1 through a wired or wireless connection to a work station, a server, a cloud, etc.

In summary, the present invention utilizes a technique of image recognition to quickly identify the type of the circuit board and the information of pins therein. Therefore, the electronic device for identifying a circuit board and the method of identifying a circuit board provided by the present invention can save users time on finding out the correct pin locations on the circuit board.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of identifying a circuit board, performed by an electronic device comprising a processing circuit, a storage circuit, a display panel, and a camera, the method comprising:
utilizing the camera to capture an image from a first circuit board corresponding to the camera;
identifying the first circuit board as a second circuit board based on a plurality of circuit board images stored in the storage circuit, wherein the image of the second circuit board is one of the plurality of circuit board images stored in the storage circuit; and
displaying the image of the first circuit board corresponding to the camera, a serial number corresponding to the first circuit board, and a virtual frame enclosing real pins of the first circuit board on the display panel at the same time.

2. The method according to claim 1, further comprising:
loading a pin configuration file to display positions of the real pins and signal categories that the real pins connect to on the display panel.

3. The method according to claim 2, further comprising:
loading a pin label file to display a specification and a manual of the real pins on the display panel.

4. The method according to claim 3, wherein the display panel comprises a searching interface for searching a specific real pin and displaying a specification and a manual of the specific real pin.

5. The method according to claim 1, wherein the electronic device is a smart phone or an augmented reality (AR) wearable device.

6. An electronic device for identifying a circuit board, comprising:
a processing circuit;
a storage circuit;
a display panel; and
a camera;
wherein the processing circuit performs a method of identifying a circuit board, the method comprising:
utilizing the camera to capture an image from a first circuit board corresponding to the camera;
identifying the first circuit board as a second circuit board based on a plurality of circuit board images stored in the storage circuit, wherein the image of the second circuit board is one of the plurality of circuit board images stored in the storage circuit; and
displaying the image of the first circuit board corresponding to the camera, a serial number corresponding to the first circuit board, and a virtual frame enclosing real pins of the first circuit board on the display panel at the same time.

7. The electronic device according to claim 6, wherein the method further comprises:
loading a pin configuration file to display locations of the real pins and signal categories that the real pins connect to on the display panel.

8. The electronic device according to claim 7, wherein the method further comprises:
loading a pin label file to display a specification and a manual of the real pins on the display panel.

9. The electronic device according to claim 8, wherein the display panel comprises a searching interface for searching a specific real pin and displaying a specification and a manual of the specific real pin.

10. The electronic device according to claim 6, wherein the electronic device is a smart phone or an augmented reality wearable device.
